(19) United States
(12) Patent Application Publication
(10) Pub. No.: US 2026/0128788 A1
(43) Pub. Date: May 7, 2026

(54) TRANSCEIVER RESILIENCY FOR EMBEDDED OPTICAL DEVICES

(71) Applicant: MELLANOX TECHNOLOGIES, LTD., Yokneam (IL)

(72) Inventors: Ran HASSON RUSO, Pardes Hanna-Karkur (IL); Isabelle CESTIER, Haifa (IL); Elad MENTOVICH, Tel Aviv (IL)

(73) Assignee: MELLANOX TECHNOLOGIES, LTD., Yokneam (IL)

(21) Appl. No.: 18/937,436

(22) Filed: Nov. 5, 2024

(51) Int. Cl. H04B 10/038; H04B 10/40

(52) U.S. Cl. CPC H04B 10/038; H04B 10/40

(57) ABSTRACT

Systems, devices, and methods for transceiver resiliency in embedded optical modules are provided. An example optical device includes an optical communication medium, a primary optical component optically coupled with the optical communication medium, and a redundant optical component optically coupled with the optical communication medium. The optical device also includes an optical switching element coupled with the primary optical component and the redundant optical component. The optical switching element selectively enables operation of the primary optical component and the redundant optical component, such as in response to operational characteristics of the primary optical component. The optical device may be embedded within an optical module.

### TECHNOLOGICAL FIELD

Example embodiments of the present disclosure relate generally to network communication and, more particularly, to transceiver resiliency for embedded optical devices.

### BACKGROUND

Datacenters, high performance computing clusters, and/or the like are often formed of various computing components or networked devices (e.g., graphics processing units (GPUs), data processing units (DPUs), hosts, servers, racks, switches, etc.). Communication networks formed of electrical and/or optical devices (e.g., modules, transceivers, switches, and/or the like) may be used to enable communication between the networked devices forming these implementations. Through applied effort, ingenuity, and innovation, many of the problems associated with conventional networking and computing systems have been solved by developing solutions that are included in embodiments of the present disclosure, many examples of which are described in detail herein.

### GENERAL DESCRIPTION

Systems, devices, and methods are disclosed herein for transceiver resiliency for embedded optical modules. An example optical device may include an optical communication medium, a primary optical component optically coupled with the optical communication medium, and a redundant optical component optically coupled with the optical communication medium. The optical device may further include an optical switching element coupled with the primary optical component and the redundant optical component. The optical switching element may be configured to selectively enable operation of the primary optical component and the redundant optical component.

In some embodiments, the optical device may be embedded within an optical module, such as within a Mid-Board Optical Module (MBOM) or Co-Packaged Optics (CPO) module. In some embodiments, the MBOM or CPO module is modular such that the MBOM or CPO module supports a plurality of redundant optical components based on the mean time between failures (MTBF) associated with the optical device.

In some embodiments, the primary optical component and the redundant optical component may be optical transmitters configured to generate optical signals.

In some further embodiments, the optical device may further include an optical element optically coupling the primary optical component and the redundant optical component with the optical communication medium.

In some embodiments, the optical switching element may include a driver and a radiofrequency (RF) switch operably coupled with the driver.

In some further embodiments, the driver may be configured to transmit a control signal to the RF switch that causes either the primary optical component or the redundant optical component to generate optical signals.

In some embodiments, the optical switching element is, in response to one or more operational characteristics of the primary optical component, configured to disable operation of the primary optical component and enable operation of the redundant optical component.

In some further embodiments, at least one of the one or more operational characteristics of the primary optical component may be indicative of a failure condition of the primary optical component.

In some embodiments, the redundant optical component may include a plurality of redundant optical components.

In any embodiment, the optical communication medium may be an optical fiber.

Additionally or alternatively, in some embodiments, the optical device may further include at least a first optical receiver. In such an embodiment, the first optical receiver may be one of a plurality of optical receivers, and a number of optical transmitters may be greater than a number of optical receivers forming the plurality.

Alternatively, in such an embodiment, the first optical receiver may be one of a plurality of optical receivers, and a number of optical transmitters may be less than a number of optical receivers forming the plurality.

In some embodiments, the primary optical component and the redundant optical component may be optical receivers configured to receive optical signals.

In some further embodiments, the optical switching element may include an optical transimpedance amplifier (TIA), a radiofrequency (RF) switch operably coupled with the TIA, the primary optical component, and the redundant optical component, and an optical switch operably coupled with the optical communication medium.

In some further embodiments, the TIA may be configured to transmit a control signal to the optical switch that causes optical signals received via the optical communication medium to be directed to either the primary optical component or the redundant optical component.

In some further embodiments, the optical device may also include a first optical element operably coupling the primary optical component with the optical switch and a second optical element operably coupling the redundant optical component with the optical switch.

In other further embodiments, the optical switching element may further include a multiplexer (MUX), a first optical transimpedance amplifier (TIA) operably coupled with the primary optical component, a second optical TIA operably coupled with the redundant optical component, and an optical switch operably coupled with the optical communication medium.

In such an embodiment, the MUX may be configured to transmit a control signal to the optical switch that causes optical signals received via the optical communication medium to be directed to either the primary optical component or the redundant optical component.

Additionally or alternatively, in some further embodiments, the optical device may include a first optical element operably coupling the primary optical component with the optical switch and a second optical element operably coupling the redundant optical component with the optical switch.

In some embodiments, the optical device may further include at least a first optical transmitter.

In such an embodiment, the first optical transmitter may be one of a plurality of optical transmitters, and a number of optical receivers may be greater than a number of optical transmitters forming the plurality.

Alternatively, in such an embodiment, the first optical transmitter may be one of a plurality of optical transmitters, and a number of optical receivers may be less than a number of optical transmitters forming the plurality.

An example optical transceiver of the present disclosure may include an optical communication medium, a primary optical transmitter optically coupled with the optical communication medium, and a redundant optical transmitter optically coupled with the optical communication medium. The optical transceiver may further include a first optical switching element coupled with the primary optical transmitter and the redundant optical transmitter, and the first optical switching element may be configured to selectively enable operation of the primary optical transmitter and the redundant optical transmitter. The optical transceiver may further include a primary optical receiver optically coupled with the optical communication medium and a redundant optical receiver optically coupled with the optical communication medium. The optical transceiver may also include a second optical switching element coupled with the primary optical receiver and the redundant optical receiver. The second optical switching element may be configured to selectively enable operation of the primary optical receiver and the redundant optical receiver.

In some embodiments, the optical transceiver may be embedded within an optical module.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate an example network architecture for implementing one or more optical devices of the present disclosure;

FIG. 2 illustrates an example optical device in accordance with one or more embodiments of the present disclosure;

FIG. 3 illustrates an example optical device with optical transmitter resiliency in accordance with one or more embodiments of the present disclosure;

FIG. 4 illustrates an example optical device with optical receiver resiliency in accordance with one or more embodiments of the present disclosure;

FIG. 5 illustrates another example optical device with optical transmitter resiliency in accordance with one or more embodiments of the present disclosure;

FIG. 6 illustrates an example optical transceiver with optical transmitter and receiver resiliency in accordance with one or more embodiments of the present disclosure;

FIG. 7 illustrates another example optical transceiver with optical transmitter and receiver resiliency in accordance with one or more embodiments of the present disclosure;

FIG. 8 illustrates an example optical transceiver with a plurality of channels each having optical transmitter and receiver resiliency in accordance with one or more embodiments of the present disclosure;

FIG. 9 illustrates an optical transceiver with asymmetrical resiliency in accordance with one or more embodiments of the present disclosure;

FIG. 10 illustrates another optical transceiver with asymmetrical resiliency in accordance with one or more embodiments of the present disclosure; and

FIG. 11 illustrates example circuitry components for, at least in part, controlling operation of one or more of the devices of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

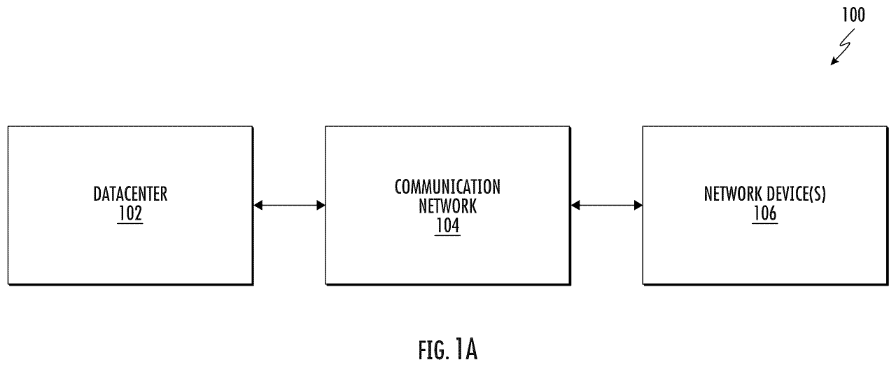

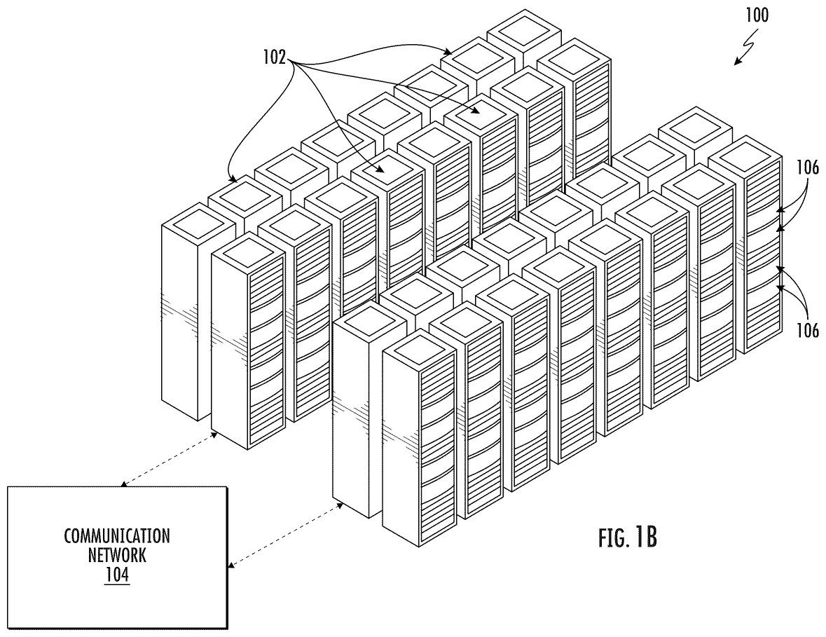

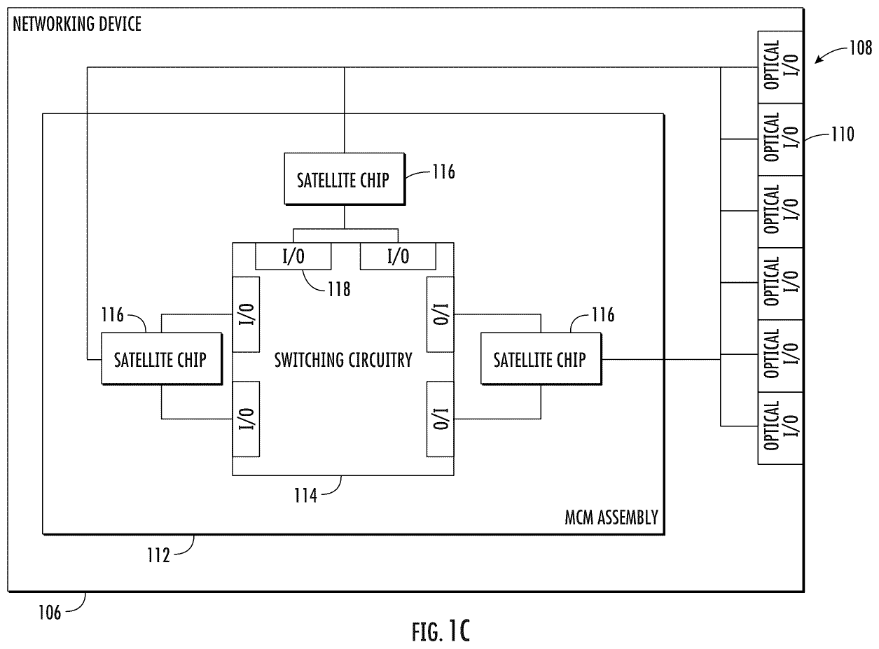

As described above, datacenters, high performance computing clusters, and/or the like are often formed of various computing components or networked devices, and communication networks formed of electrical and/or optical devices may be used to enable communication between the networked devices forming these implementations. With reference to FIGS. 1A-1B, for example, a network architecture 100 may include a datacenter 102, a communication network 104, and network device(s) 106. The network architecture 100 may illustrate a general computing architecture within which more specific systems and/or subsystems may function. Although described hereinafter with reference to a network architecture 100 and/or datacenter 102 within which the embodiments of the present disclosure may be implemented, the present disclosure contemplates that the transceiver resiliency devices and techniques described herein may be applicable to any communication implementation without limitation.

For example, the datacenter 102 may be a centralized facility designed to house computing resources and related components. The datacenter 102 may operate to support the infrastructure required for advanced computational tasks, for efficient, secure, and reliable operations. The datacenter 102 may include the building and structural components, including power supplies, cooling systems, fire suppression systems, and physical security measures that are configured to maintain optimal operating conditions and/or protect the equipment from environmental hazards and unauthorized access. An example datacenter 102 may include high-performance servers or compute nodes, often arranged in racks, such as those illustrated in FIG. 1B, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The datacenter 102 may include high-speed network equipment, such as network switches, routers, firewalls, and/or the like to facilitate fast and secure data transmission within the datacenter 102 (e.g., between the servers or compute nodes) and between external networks. The datacenter 102 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 102 may support high-performance computing tasks. Examples of various network topologies may include hierarchical networking topologies such as the fat tree topology, Slim Fly topology, Dragonfly topology, and/or the like. In at least one example embodiment, the datacenter 102 may correspond to a collection of network devices, such as network switches (e.g., Ethernet switches or the like) connected with a collection of servers or compute nodes. The datacenter 104 may be configured to route traffic amongst the network switches and servers therein, and at least one layer of the topology in the datacenter 104 may be coupled to the communication network 108 to allow networking traffic to flow between the datacenter 104 and the network device(s) 112.

The communication network 104 may communicably couple the datacenter 102 with network device(s) 106 and other external devices for data exchange and connectivity. Examples of the communication network 104 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 104 to incorporate multiple network types and configurations may allow the datacenter 102 to adapt to diverse application needs, from general data communication to specialized HPC tasks. As described herein, the communication network 104 may leverage various optical components to establish communication links (e.g., communicably couple) between components in the architecture 100. As such, the communication network 104 may include various optical devices, transceivers, modules, and/or the like that are configured to generate optical signals (e.g., provide optical transmitter functionality) and/or receive optical signals (e.g., provide optical receiver functionality).

The network device(s) 106 may include a variety of computing devices capable of transmitting and receiving signals over the communication network 104. The network device(s) 106 may range from personal computing devices to complex server configurations. Examples include Personal Computers (PCs), laptops, tablets, smartphones, and servers. The network device(s) 106 may facilitate user interactions with the datacenter 102, allowing for data input, retrieval, and processing from remote locations. In addition to individual computing devices, the network device(s) 106 may also include collections of servers or additional datacenters. For instance, these could be other datacenters similar to or the same as datacenter 102. Such an interconnection may allow for the formation of a distributed computing environment for improved redundancy, load balancing, and disaster recovery capabilities. By linking multiple datacenters, the network architecture 100 may leverage geographically dispersed resources, optimizing performance and ensuring high availability.

As described herein, the datacenter 102 and/or the network device(s) 106 may include storage devices and processing circuitry for executing computing tasks, such as controlling the flow of data internally and over the communication network 104. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the datacenter 102 and network device(s) 106 may include one or more communication interfaces for facilitating wired and/or wireless communication between one another and other unillustrated elements of the network architecture 100. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 100.

Furthermore, the present disclosure contemplates that the network architecture 100 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 100 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 100.

In high-capacity datacenter networks, such as those illustrated in FIGS. 1A-1B, the communication network 104 may leverage optical transceivers that transmit and receive optical signals over optical fibers or other optical communication mediums in order to establish connection between devices in the architecture 100. When a failure occurs in a transceiver (e.g., hardware end-of-life, environmental failure, random failure, etc.) the optical link between components is broken thereby impacting the network's performance. In conventional network architectures that often use pluggable form factor based transceivers, an operator may be required to manually replace the transceiver when a link is down. By way of example, a system may include a limited number of spare transceivers that may replace a faulty transceiver, and an operator may eventually be required to manually replace the transceiver (e.g., faulty or otherwise). A transceiver is faulty as soon as one link is down, even if the other lanes of this transceiver are operating normally thereby resulting in costly maintenance.

The advent of Mid-Board Optical Modules (MBOM) and Co-Packaged Optics (CPO) provide an emerging solution for the integration for optics and silicon that address next generation bandwidth and power challenges. In these implementations, however, the transceiver is embedded within the CPO and MBOM architecture. As such, the replacement of a transceiver (e.g., due to a failure condition or otherwise) within the CPO and/or MBOM architecture is impossible or otherwise impracticable. For example, replacement of the transceiver may (1) damage the module within which the transceiver is embedded, (2) significantly impact performance of the CPO/MBOM based systems, and/or (3) increase maintenance costs due the direct connectivity in these implementations.

With reference to FIG. 1C, for example, high-capacity optical switch assemblies may switch multiple channels of data at high data rates, with the number of channels reaching several hundreds and data rates reaching hundreds of Gb/s (Gb/s=10⁹ bits per second). In order to save power, it may be desirable to co-package the switch itself with “optical engines,” which typically are small, high-density optical transceivers located within an application-specific integrated circuit (ASIC) or within an ASIC package together with the switch. The switch assembly may be contained in a rack-mounted case with optical receptacles on its front panel for ease of access. The signals to and from the ASIC may be conveyed to and from the optical receptacles using optical fibers.

Space constraints of the switch and the front panel may limit the number of optical fibers connected to the ASIC and the optical receptacles on the panel. Therefore, the optical signals emitted and received by the switch may be multiplexed using wavelength-division multiplexing, so that each fiber, along with the associated optical receptacle, carries multiple optical signals. For example, each fiber may carry four channels of 100 Gb/s each, at four different, respective wavelengths, to and from the corresponding optical receptacle, for a total data rate of 400 Gb/s (denoted as 4×100 Gb/s).

In many cases, the multiple communication channels carried at different wavelengths on the same fiber are directed to and from different network nodes. For example, each of the 100 Gb/s component signals on a 4×100 Gb/s optical link may be directed to a different server. Therefore, there is a need for an optical cable that is capable of splitting the multiplexed optical signal into multiple component signals at different, respective wavelengths, and is capable of conveying each of these signals to a different network node. For simplicity of installation and use, it is desirable that the optical cable be “active,” meaning that transceivers in the cable convert each of the multiple optical signals to a standard electrical form (and vice versa). As a result, the network nodes need process only electrical signals and will be indifferent to the actual wavelength of the optical channel that is directed to each of them. To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

Co-packaging may therefore refer to the close integration of different electrical and/or optoelectronic chips in the same package. As shown in FIG. 1C, for example, the different chips that constitute the co-packaged system may be assembled on a single substrate in what is typically called the MCM assembly 112. The MCM assembly 112 may include switching circuitry 114 surrounded by peripheral or satellite chips 116. Various example configurations of an MCM assembly 112 are described in further detail herein. In some embodiments, the switching circuitry 114 and surrounding satellite chips 116 are all mounted on a common substrate, although such a configuration is not required. The MCM assembly 112 may be provided in a larger housing of the networking device 106 positioned behind the front panel 108. The switching circuitry 114 may include one or more core digital Application Specific Integrated Circuits (ASICs), CPUs, GPUs, microprocessors, FPGAs, combinations thereof, and the like. The switching circuitry 114 may include a number of input ports and/or output ports 110. The Input/Output (I/O) ports 118 may include electrical ports and/or optical ports. Additionally, the switching circuitry 114 may include a combination of electrical blocks and optical blocks. The electrical blocks of the switching circuitry 114 may include a number of electrical switches that are configured to route signals in an electrical domain. The optical blocks of the switching circuitry 114 may include a number of optical components that are configured to generate, detect, and route signals in an optical domain. The MCM assembly 112, in some embodiments, may concern or include multiple satellite chips 116 that are assembled on the same substrate as the switching circuitry 114. In some embodiments, a configuration of the optical block(s) and a configuration of the electrical block(s) depends (e.g., is based on) on the number of optical ports in the I/O ports 118.

As discussed above, optical I/Os 110, which may also be referred to as optical connectors, are placed at the front panel 108. As mentioned above, connectivity between the MCM assembly 112 and optical I/Os 110 may be transferred to the front panel 108 through optical fibers. This connection may be made directly with an optical I/O 118 of the switching circuitry or may be made with one or more of the satellite chips 116. The connection is often made with one or more of the satellite chips 116 because the satellite chips 116 may include the electro-optic converters and, possibly, the SERDES to natively support the connection. The satellite chips 116 may include one or more of a DSP processor, driver, trans-impedance amplifier, laser, modulator, photodiode, serializer-deserializer, or the like.

Thus, in order to address these problems and others, the embodiments of the present disclosure provide redundancy of optical transmitters and/or receivers within the transceivers that are embedded in CPO and MBOM architectures. For example, the embedded transceivers described herein may include a primary optical component, a redundant optical component, and an optical switching element that selectively enables operation of the primary/redundant optical component, such as in response to a failure condition. The redundancy of some elements within the transmitter and the receiver parts for each lane creates an alternative path for the data in case of failure. This may be achieved by a modular design that allows and supports the addition of multiple backup components—in accordance with the needed lifetime of the transceiver. This allows the incorporation of multiple components that address each component specific mean time between failures (MTBF). These embodiments may, for example, provide resiliency for the transmitting side of the transceiver and/or the receiving side of the transceiver, expand the system's MTBF and high-performance periods, and may further provide resiliency for a plurality of communication channels based on the number of channels employed by the associated CPO and MBOM architecture. These embodiments may, for example, provide two alternative paths per lane, one at the transmitter side and one at the receiver side. After detecting failure in a lane, a control signal allows for a change in the data path on the transceiver itself for the specific lane to keep that lane operating. The embodiments described herein therefore improve the lifetime of a transceiver by switching from a defective path to a healthy one for the same lane, extending the operation time of the transceiver before replacement.

This basic design may be extended, according to the needed performance and the needed MTBF for the transceiver by the following equation [MTBF_{transceiver}=MIN[(MTBF_{TX})^{NTX}, (MTBF_{(RX})^{NRX}] in which: MTBF_{transceiver} is the MTBF for the transceiver, MTBF_{TX} is the MTBF for the transmitter part, MTBF_{RX} is the MTBF for the receiver part, NTX is the number of alternative paths per TX lane, and NRX is the number of alternative paths per RX lane. The number of alternative paths may be determined by the ability to design a transceiver fulfilling the required specifications for its usage. Some example design parameters may include signal integrity, noise level, cross-talk, data rate, footprint, heating management, among others.

### Example Optical Devices

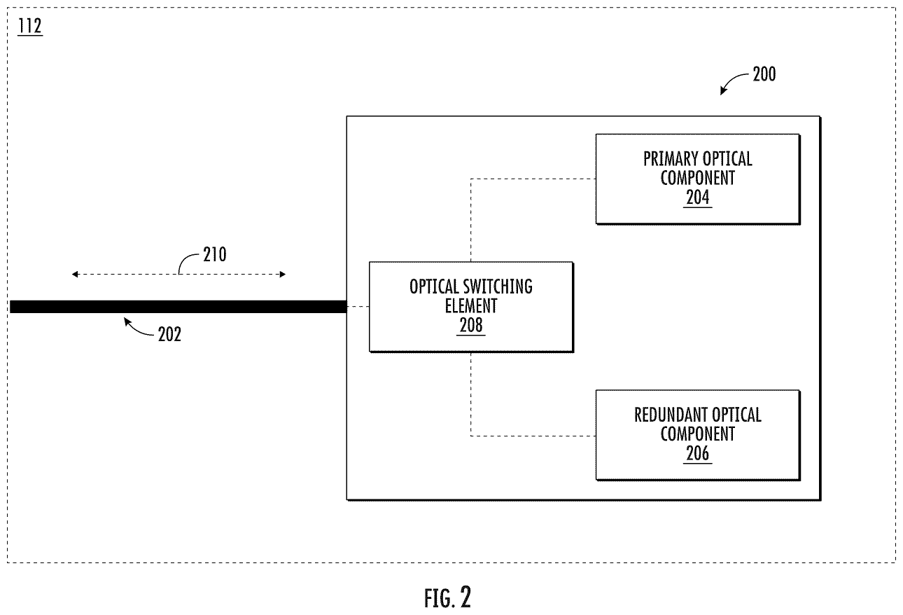

With reference to FIG. 2, an example optical device 200 of the present disclosure is illustrated. As shown, the optical device 200 may include an optical communication medium 202, a primary optical component 204, a redundant optical component 206, and an optical switching element 208. The optical communication medium 202 may, for example, include an optical fiber configured to support the transmission of optical signals 210 (e.g., light encoding underlying data). The present disclosure contemplates that the optical communication medium 202 may include any number of optical fibers to support the corresponding number of optical communication channels supported by the optical devices 200 described herein. Furthermore, although described herein with reference to optical fiber(s) as an example optical communication medium, the present disclosure contemplates that the optical communication medium 202 may include any structure, device, or the like through which light may propagate without limitation.

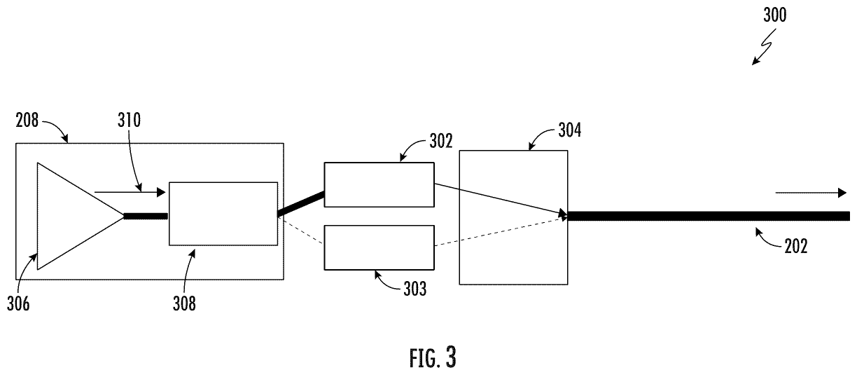

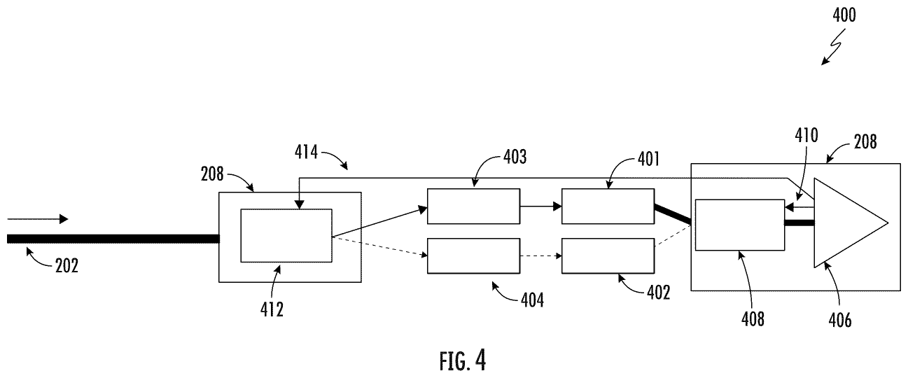

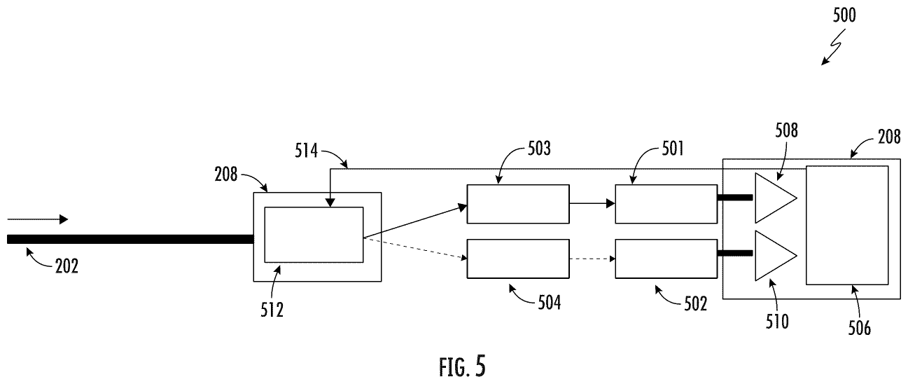

With continued reference to FIG. 2, the primary optical component 204 may be optically coupled with the optical communication medium 202, and the redundant optical component 206 may also be optically coupled with the optical communication medium 202. As described hereafter with reference to FIG. 3, in some embodiments, the primary optical component 204 and the redundant optical component 206 may be optical transmitters configured to generate optical signals. By way of example, the primary optical component 204 and the redundant optical component 206 may each be lasers (e.g., vertical-cavity surface-emitting lasers (VCSELs)) or the like that generate optical signals (e.g., light encoding underlying data). In such an embodiment, the optical signals 210 of FIG. 2 may refer to optical signals generated by one or more of the primary optical component 204 and the redundant optical component 206 of the optical device 200. As described hereafter with reference to FIGS. 4-5, in some embodiments, the primary optical component 204 and the redundant optical component 206 may be optical receivers configured to receive optical signals. By way of example, the primary optical component 204 and the redundant optical component 206 may each be photodetectors (e.g., photodiodes (PDs)) or the like that receive optical signals (e.g., light encoding underlying data). In such an embodiment, the optical signals 210 of FIG. 2 may refer to optical signals received, via the optical communication medium 202, by one or more of the primary optical component 204 and the redundant optical component 206 of the optical device 200.

The optical device 200 of FIG. 2 may further include an optical switching element 208 coupled with the primary optical component 204 and the redundant optical component 206. As described further hereafter, the optical switching element 208 may be configured to selectively enable operation of the primary optical component 204 and the redundant optical component 206. In an instance in which the optical device 200 provides optical transmitting functionality as described hereafter with reference to FIG. 3, the optical switching element 208 may, for example, include a driver and a radiofrequency (RF) switch operably coupled with the driver. The driver may be configured to transmit a control signal to the RF switch that causes either the primary optical component 204 or the redundant optical component 206 to generate optical signals.

In an instance in which the optical device 200 provides optical receiving functionality as described hereafter with reference to FIGS. 4-5, the optical switching element 208 may, for example, include an optical transimpedance amplifier (TIA), a radiofrequency (RF) switch operably coupled with the TIA, the primary optical component 204, and the redundant optical component 206, and an optical switch operably coupled with the optical communication medium 202. In such an embodiment, the optical TIA may be configured to transmit a control signal to the optical switch that causes optical signals received via the optical communication medium 202 to be directed to either the primary optical component 204 or the redundant optical component 206. Additionally or alternatively, in another optical receiving implementation, the optical switching element 208 may include a multiplexer (MUX), a first optical transimpedance amplifier (TIA) operably coupled with the primary optical component 204, a second optical TIA operably coupled with the redundant optical component 206, and an optical switch operably coupled with the optical communication medium 202. In such an implementation, the MUX may be configured to transmit a control signal to the optical switch that causes optical signals received via the optical communication medium 202 to be directed to either the primary optical component 204 or the redundant optical component 206.

In any of the embodiments described herein, the optical switching element 208 may be configured to, in response to one or more operational characteristics of the primary optical component 204, disable operation of the primary optical component 204 and enable operation of the redundant optical component 206. By way of a nonlimiting example, one or more of the operational characteristics of the primary optical component may be indicative of a failure condition of the primary optical component 204 such that the primary optical component 204 is incapable of effectively generating and/or receiving optical signals. In such an example embodiment, the optical switching element 208 may cause the redundant optical component 206 to generate optical signals for transmission by the optical device 200 or cause optical signals received by the optical device 200 to be directed to the redundant optical component 206. Although described herein with reference to an example failure condition for the primary optical component 204, the present disclosure contemplates that any state, condition, status, etc. associated with the primary optical component 204 may be used by the optical switching element 208 (e.g., maintenance required, excessive environment conditions present, etc.). Furthermore, the present disclosure contemplates that the determination of a failure condition may be based on any attribute, characteristics, parameters, features, metric, etc. associated with the primary optical component 204.

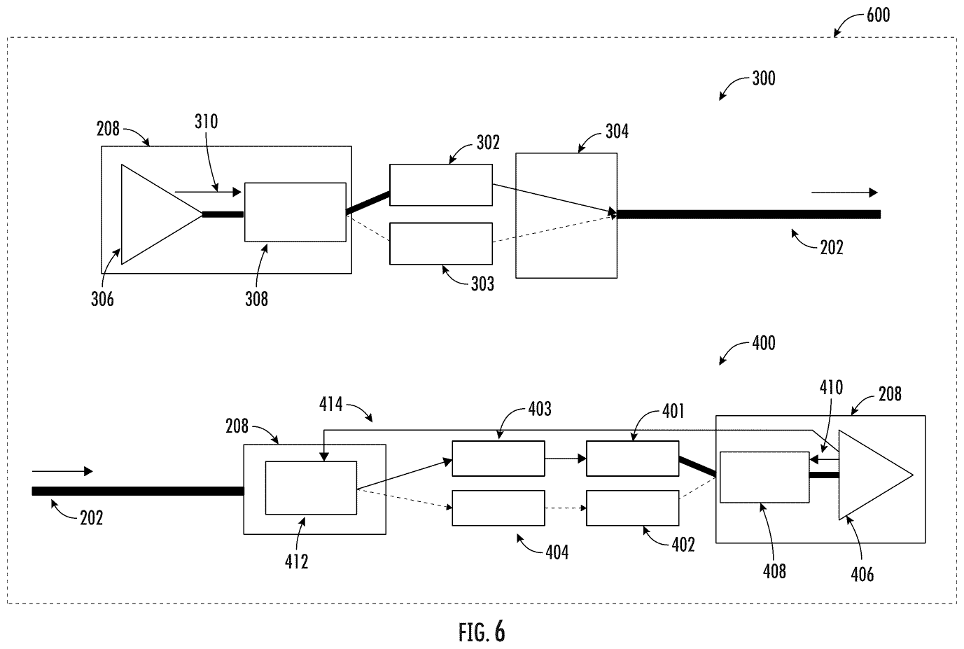

The present disclosure contemplates that the arrangement, ordering, positioning, and/or configuration of the primary optical component 204, the redundant optical component 206, and/or the optical switching element 208 illustrated in FIG. 2 may vary based on the operation (e.g., transmitting or receiving) of these components or the optical device 200 comprising these components. Said differently, the optical device 200 of FIG. 2 illustrates a generalized component resiliency configuration that may be applicable to both optical transmitting implementations and optical receiving implementations. As described hereafter with reference to FIGS. 6-10, the present disclosure further contemplates that the components and functionality of the optical device 200 may be incorporated into an optical transceiver that provides resiliency for both optical transmitting and optical receiving functionality.

As described above, the optical devices of the present disclosure, such as the optical device 200, may be embedded within an optical module. In particular, the optical device 200 may be embedded as part of a Mid-Board Optical Modules (MBOM) and/or Co-Packaged Optics (CPO) implementation, such as illustrated in FIG. 1C. As described above, MBOM and CPO implementations provide for the integration for optics and silicon that address next generation bandwidth and power challenges. This integration, however, results in the requirement that the transceiver components (e.g., optical transmitters and/or optical receivers) be embedded within the MBOM or CPO architecture. Unlike conventional pluggable transceiver based solutions in which the transceiver may simply be removed (e.g., “un-plugged”) from the network device, replacement of a transceiver within the CPO and/or MBOM architecture is impossible or otherwise impracticable. Said differently, attempting to remove embedded optical transceiver comments (e.g., the components of optical device 200) may result in damage to the structure of the CPO and MBOM architectures that are integrally formed in the datacenter implementation. As such, the resiliency provided by the embodiments described herein is directed to optical devices that are embedded within optical modules, such as CPO and MBOM architecture. Although described herein with reference to the embedded nature of the optical device 200, the present disclosure contemplates that the optical device 200 and the components forming the optical device 200 may be formed integrally with an optical module, permanently affixed/attached with optical module, directly connected with an optical module, and/or the like without limitation.

### Example Transmitting Resiliency

With reference to FIG. 3, an example optical device 300 with optical transmitter resiliency is illustrated. As shown, the optical device 300 may include an optical communication medium 202 as described above with reference to FIG. 2. The optical device 300 may further include a primary optical component 302 optically coupled with the optical communication medium 202 that is an optical transmitter configured to generate optical signals and a redundant optical component 303 optically coupled with the optical communication medium 202 and similarly configured to generate optical signals. As above, the primary optical component 302 and the redundant optical component 303 may be lasers (e.g., VCSELs or the like) that generate optical signals (e.g., light encoding data) for transmission via the optical communication medium 202. The optical device 300 may further include an optical element 304 optically coupling the primary optical component 302 and the redundant optical component 303 with the optical communication medium 202. The optical element 304 may include one or more lenses, mirrors, filters, diffusers, and/or similar components for interfacing between the optical communication medium 202 and the optical components 302, 303. The present disclosure contemplates that the optical element 304 may refer to any structure that operates to align the components 302, 303 with the optical communication medium 202 and/or direct the optical signals between the components 302, 303 and the optical communication medium 202.

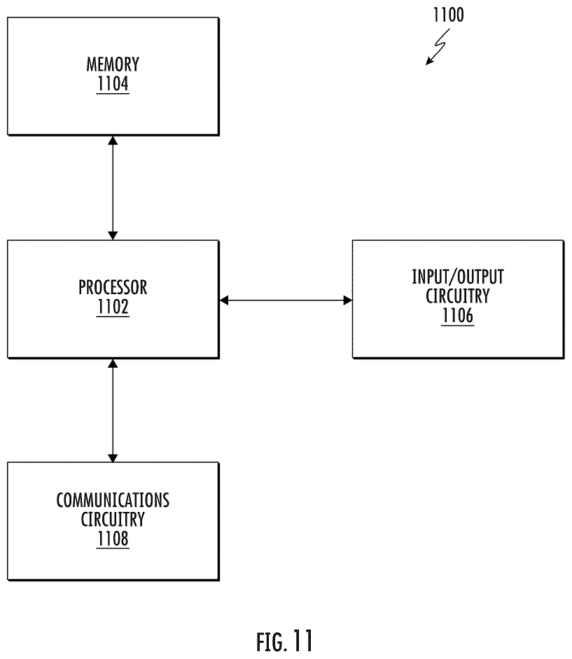

In the optical device 300 of FIG. 3, the optical switching element 208, as described above with reference to FIG. 2, may include a driver 306 and a radiofrequency (RF) switch 308 operably coupled with the driver 306. As would be evident to one of ordinary skill in the art in light of the present disclosure, the driver 306 may refer to any circuit or component used to control other circuits or components and, as such, may include relevant circuitry components for performing these operations. The RF switch 308 may be any solid state switch, electromechanical switch (e.g., electromagnetic induction based switch), or the like configured to switch between different configurations (e.g., between positions, inputs/outputs, etc.). As described above, the driver 306 may be configured to transmit a control signal 310 to the RF switch 308 that causes either the primary optical component 302 or the redundant optical component 303 to generate optical signals. For example, various operational characteristics of the primary optical component 302 may be determined (e.g., such as via the circuitry described herein with reference to FIG. 11) that are indicative of a failure condition for the primary optical component 302. The driver 306 (e.g., in response to received instructions or via local determinations) may generate and transmit a control signal 310 to the RF switch 308 that causes the primary optical component 302 to be disabled and causes the redundant optical component 303 to be enabled. By way of a nonlimiting example, the RF switch 308 may cause power previously supplied to the primary optical component 302 to be directed to the redundant optical component 303. Although described herein with reference to a driver 306 and RF switch 308, the present disclosure contemplates that the optical switching element 208 of the optical device 300 may leverage any mechanism for selectively disabling operation of the optical components 302, 303.

### Example Receiving Resiliency

With reference to FIGS. 4-5, example optical devices 400, 500 with optical transmitter resiliency are illustrated. As shown in FIG. 4, the optical device 400 may include a primary optical component 401 and a redundant optical component 402 that are optical receivers configured to receive optical signals. As described above, the components 401, 402 may be optically coupled with the optical switching element 208 and the optical communication medium 202. By way of example, the primary optical component 401 and the redundant optical component 402 may each be photodiodes (PDs) or the like that receive optical signals (e.g., light encoding underlying data). The optical device 400 may further include a first optical element 403 operably coupling the primary optical component 401 with an optical switch 412 described hereafter and a second optical element 404 operably coupling the redundant optical component 402 with the optical switch 412. As above, the first and the second optical elements 403, 404 may include one or more lenses, mirrors, filters, diffusers, and/or similar components for interfacing between the optical communication medium 202 and the components 401, 402.

In the optical device 400 of FIG. 4, the optical switching element 208, as described above with reference to FIG. 2, may include an optical transimpedance amplifier (TIA) 406, a radiofrequency (RF) switch 408 operably coupled with the TIA 406, the primary optical component 401 and the redundant optical component 402, and an optical switch 412 operably coupled with the optical communication medium 202. As would be evident to one of ordinary skill in the art in light of the present disclosure, the optical TIA 406 operates as structure or mechanism for converting current (e.g., received from the PDs acting as the components 401, 402) to an associated differential voltage (e.g., an electrical signal). As such, the RF switch control signal 410 may refer to the control via the optical TIA 406 of the optical components 401, 402 as related to this conversion and subsequent data generation. As above, the RF switch 408 may be any solid state switch, electromechanical switch (e.g., electromagnetic induction based switch), or the like configured to switch between different configurations (e.g., between positions, inputs/outputs, etc.). The optical switch 412 may refer to a structure or collection of components (e.g., collimators, mirrors, rotating mirrors, Micro-Electro-Mechanical systems (MEMS) controllers, or the like) that operate to direct light (e.g., optical signals) received from the optical communication medium 202 to either the primary optical component 401 (e.g., primary optical receiver) or the redundant optical component 402 (e.g., redundant optical receiver).

The optical TIA 406 may further generate and transmit a control signal to the optical switch 412 to causes the optical signals from the optical communication medium 202 to be directed to either the primary optical component 401 or the redundant optical component 402 to generate optical signals. For example, various operational characteristics of the primary optical component 401 may be determined (e.g., such as via the circuitry described herein with reference to FIG. 11) that are indicative of a failure condition for the primary optical component 401. The optical TIA 406 (e.g., in response to received instructions or via local determinations) may generate and transmit a control signal 414 to the optical switch 412 that causes the optical signals to be directed to the redundant optical component 402 as opposed to the primary optical component 401.

As shown in FIG. 5, the optical device 500 may a primary optical component 501 and a redundant optical component 502 that are optical receivers configured to receive optical signals. As described above, the components 501, 502 may be optically coupled with the optical switching element 208 and the optical communication medium 202. As above, the primary optical component 501 and the redundant optical component 502 may each be photodiodes (PDs) or the like that receive optical signals (e.g., light encoding underlying data). The optical device 500 may further include a first optical element 503 operably coupling the primary optical component 501 with an optical switch 512 and a second optical element 504 operably coupling the redundant optical component 502 with the optical switch 512. Similar to the optical device 400 of FIG. 4, the first and the second optical elements 503, 504 may include one or more lenses, mirrors, filters, diffusers, and/or similar components for interfacing between the optical communication medium 202 and the components 501, 502.

In the optical device 500 of FIG. 5, the optical switching element 208, as described above with reference to FIG. 2, may include a multiplexer 406, a first optical transimpedance amplifier (TIA) 508 operably coupled with the primary optical component 501, a second optical TIA 510 operably coupled with the redundant optical component 502, and an optical switch 512 operably coupled with the optical communication medium 202. As would be evident to one of ordinary skill in the art in light of the present disclosure, the first and the second optical TIAs 508, 510 may operates as described above to convert current to an associated differential voltage (e.g., an electrical signal) for the respective components 501, 502. The multiplexer 506 refers to a device that allows for a plurality of optical signals to be combined (e.g., multiplexed) on a common optical communication medium (e.g., via wavelength division multiplexing (WDM) or the like). In the optical device 500 of FIG. 5, the MUX 506 may generate and transmit a control signal 514 to the optical switch 512 that causes optical signals received from the optical communication medium 202 to be directed to either the primary optical component 501 (e.g., primary optical receiver) or the redundant optical component 502 (e.g., redundant optical receiver). As above, the optical switch 512 may refer to a structure or collection of components (e.g., collimators, mirrors, rotating mirrors, Micro-Electro-Mechanical systems (MEMS) controller, or the like) that operate to direct light.

### Example Transceiver Implementations

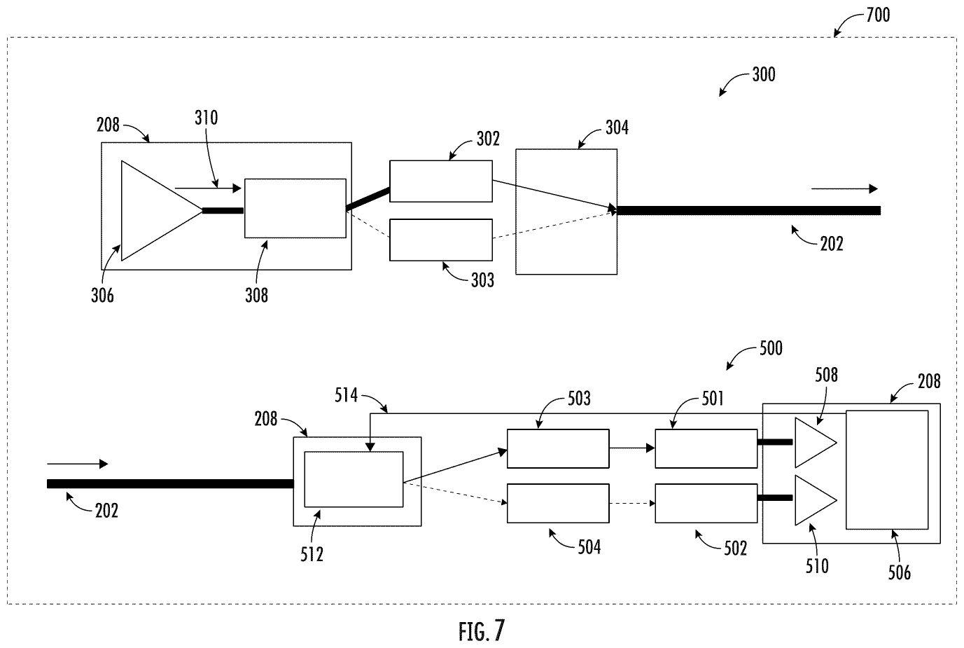

With reference to FIGS. 6-7, example transceivers 600 and 700 are illustrated. As shown in FIG. 6, in some embodiments, an optical transceiver 600 that may be, for example, embedded in an optical modules (e.g., MBOM or CPO architecture) may include the optical device 300 of FIG. 3 in conjunction with the optical device 400 of FIG. 4. In particular, the components described with reference to FIG. 3 may be included in the example transceiver 600 to provide resiliency for the optical transmitting operations of the transceiver 600, and the components described with reference to FIG. 4 may be included in the example transceiver 600 to provide resiliency for the optical receiving operations of the transceiver 600. As shown in FIG. 7, in some embodiments, an optical transceiver 700 that may be, for example, embedded in an optical modules (e.g., MBOM or CPO architecture) may include the optical device 300 of FIG. 3 in conjunction with the optical device 500 of FIG. 5. In particular, the components described with reference to FIG. 3 may be included in the example transceiver 700 to provide resiliency for the optical transmitting operations of the transceiver 700, and the components described with reference to FIG. 5 may be included in the example transceiver 700 to provide resiliency for the optical receiving operations of the transceiver 700. By way of a non-limiting example, the example transceiver 600 in FIG. 6 may include a primary optical component 302 as the primary optical transmitter, a redundant optical component 303 as the redundant optical transmitter, and an optical switching element 208 as the first optical switching element. Said differently, the first optical switching element may refer to the optical switching element 208 (e.g., of the optical device 300) coupled with the primary optical transmitter (e.g., primary optical component 302) and redundant optical transmitter (e.g., redundant optical component 303). The example transceiver may include a primary optical component 401 as the primary optical receiver, a redundant optical component 402 as the redundant optical receiver, and an optical switching element 208 as the second optical switching element. Said differently, the second optical switching element may refer to the optical switching element 208 (e.g., of the optical device 400) coupled with the primary optical receiver (e.g., primary optical component 401) and redundant optical receiver (e.g., redundant optical component 402). This construction may be similarly applicable to the transceivers 700, 800, 900, 1000 of FIGS. 7-10, respectively.

As would be evident to one of ordinary skill in the art in light of the present disclosure, the transceivers 600 and 700 may be configured for sending and receiving signals, for example, data signals. The data signals may be digital or optical signals modulated with data or other suitable signals for carrying data. The transceivers 600, 700 may include a digital data source, a transmitter (e.g., optical components 302, 303 operating as lasers or the like), a receiver (e.g., optical components 302, 303 operating as photodetectors or the like) and processing circuitry (e.g., processor 1102 in FIG. 11) that controls the transceiver 600, 700. The digital data source may include suitable hardware and/or software for outputting data in a digital format (e.g., in binary code and/or thermometer code). The digital data output by the digital data source may be retrieved from memory or generated according to input (e.g., user input). The transmitter includes suitable software and/or hardware for receiving digital data from the digital data source and outputting data signals according to the digital data for transmission over the communication network 104 to a receiver of another network device 106. The receiver may similarly include suitable hardware and/or software for receiving signals, such as data signals from the communication network 104.

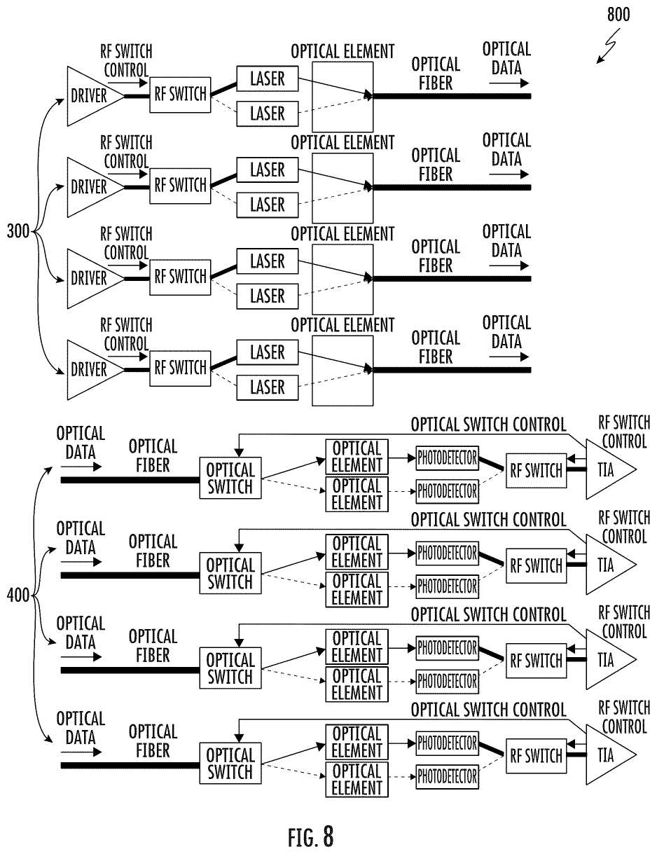

Although illustrated in FIGS. 6-7 with a single resiliency solution for the transmitting operations (e.g., one set of the components illustrated in FIG. 3) and a single resiliency solution for the receiving operations (e.g., one set of the components illustrated in either FIG. 4 or FIG. 5), the present disclosure contemplates that the transceivers described herein may include any number of resilience or redundant optical components based on the intended application of the transceiver. For example, as illustrated in FIG. 8, an example transceiver 800 may include resiliency for each of a plurality of optical transmission lanes (e.g., transmitter-fiber-receiver) and resiliency for each of a plurality of optical receiving lanes. Although illustrated in the transceiver 800 of FIG. 8 with four (4) transmitting and receiving lanes, the present disclosure contemplates that any number of communication lanes may be used and that the resiliency provided by the embodiments described herein need not be symmetrical.

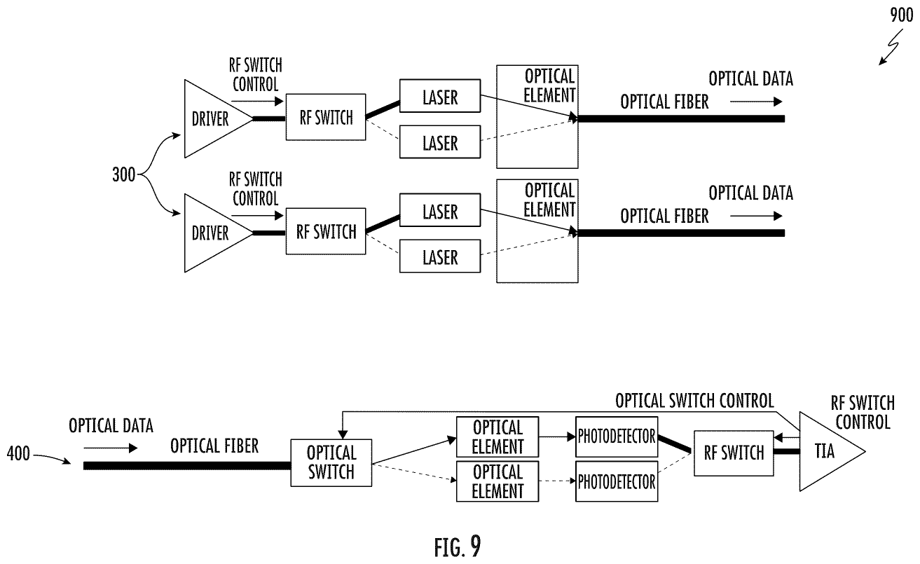

With reference to FIG. 9, for example, a transceiver 900 is illustrated in which a plurality of the components described above with reference to FIG. 3 (e.g., multiple optical devices 300) further include at least a first optical receiver (e.g., the components of the optical device 400 for example). In such an embodiment, this example first optical receiver may be one of a plurality of optical receivers, but a number of optical transmitters may greater than a number of optical receivers forming the plurality such that an asymmetric implementation is provided. The present disclosure contemplates that in such an asymmetric implementation in which the number of resiliency solutions for optical transmitters exceeds that of optical receivers, any number of resiliency solutions may be provided so long as the number of optical transmitters exceeds the number of optical receivers as shown.

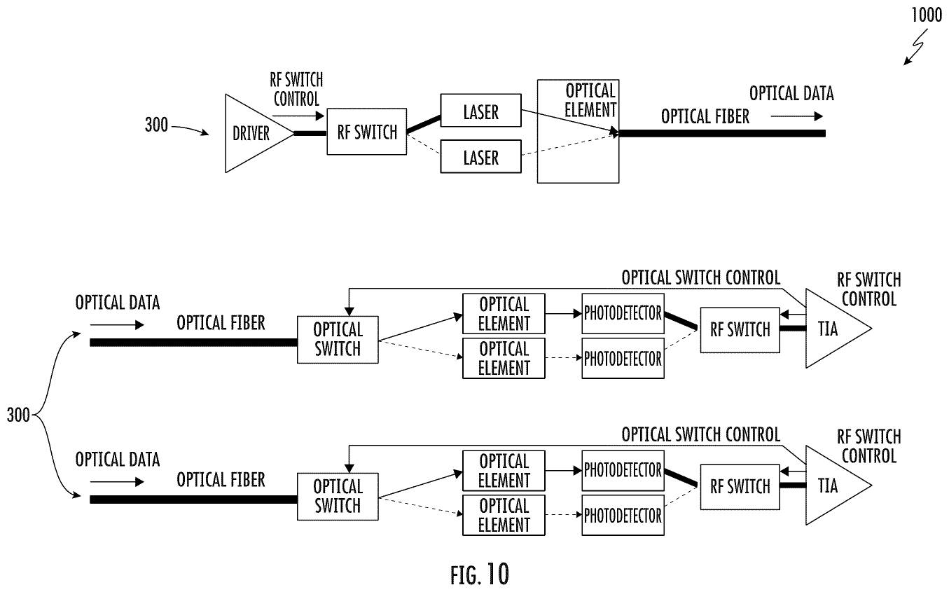

Alternatively, with reference to FIG. 10, for example, a transceiver 1000 is illustrated in which a plurality of the components described above with reference to FIG. 4 (e.g., multiple optical devices 400) further include at least a first optical transmitter (e.g., the components of the optical device 300). In such an embodiment, this example first optical transmitter 300 may also be one of a plurality of optical transmitter, but a number of optical receivers may greater than a number of optical receivers forming the plurality such that an asymmetric implementation is provided. The present disclosure contemplates that in such an asymmetric implementation in which the number of resiliency solutions for optical receiver exceeds that of optical transmitter, any number of resiliency solutions may be provided so long as the number of optical receivers exceeds the number of optical transmitters as shown.

### Example Circuitry

With reference to FIG. 11, a block diagram of example circuitry (e.g., circuity 1100) that may, in whole or in part, impact control of the optical devices described herein is illustrated in accordance with some example embodiments. The circuitry 1100 may be communicably coupled with any of the optical devices and/or optical transceivers described herein. However, it should be noted that the components, devices or elements illustrated in and described with respect to FIG. 11 below may not be mandatory and thus one or more may be omitted in certain embodiments. Additionally, some embodiments may include further or different components, devices or elements beyond those illustrated in and described with respect to FIG. 11. In some embodiments, the optical devices and/or optical transmitters may comprise one or more of the components illustrated and described with reference to FIG. 11.

Although the term “circuitry” as used herein with respect to components 1102-1108 is described in some cases using functional language, it should be understood that the particular implementations necessarily include the use of particular hardware configured to perform the functions associated with the respective circuitry as described herein. It should also be understood that certain of these components 1102-1108 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with these embodiments may be housed together, while other components are housed separately. While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. For example, the processor 1102 may provide processing functionality, the memory 1104 may provide storage functionality, the communications circuitry 1108 may provide network interface functionality, and the like.

In some embodiments, the processor 1102 (and/or co-processor or any other processing circuitry assisting or otherwise associated with the processor) may be in communication with the memory 1104 via a bus for passing information among components. The memory 1104 may be non-transitory and may include, for example, one or more volatile and/or non-volatile memories, or some combination thereof. In other words, for example, the memory 1104 may be an electronic storage device (e.g., a non-transitory computer readable storage medium).

Although illustrated in FIG. 11 as a single memory, the memory 1104 may comprise a plurality of memory components. The plurality of memory components may be embodied on a single computing device or distributed across a plurality of computing devices. In various embodiments, the memory 1104 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 1104 may be configured to store information, data, applications, instructions, or the like for enabling these embodiments to carry out various functions in accordance with example embodiments discussed herein. For example, in at least some embodiments, the memory 1104 may be configured to buffer data for processing by the processor 1102. Additionally, or alternatively, in at least some embodiments, the memory 1104 may be configured to store program instructions for execution by the processor 1102. The memory 1104 may store information in the form of static and/or dynamic information.

The processor 1102 may be embodied in a number of different ways and may, for example, include one or more processing devices configured to perform independently. Additionally, or alternatively, the processor 1102 may include one or more processors configured in tandem via a bus to enable independent execution of instructions, pipelining, and/or multithreading. The processor 1102 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 11 as a single processor, in some embodiments, the processor 1102 may include a plurality of processors. The plurality of processors may be embodied on a single computing device or may be distributed across a plurality of such devices collectively.

In an example embodiment, the processor 1102 may be configured to execute instructions stored in the memory 1104 or otherwise accessible to the processor 1102. Alternatively, or additionally, the processor 1102 may be configured to execute hard-coded functionality. As such, whether configured by hardware or software methods, or by a combination thereof, the processor 1102 may represent an entity (e.g., physically embodied in circuitry) capable of performing operations according to an embodiment of the present disclosure while configured accordingly. Alternatively, as another example, when the processor 1102 is embodied as an executor of software instructions, the instructions may specifically configure the processor 1102 to perform one or more algorithms and/or operations described herein when the instructions are executed. For example, these instructions, when executed by the processor 1102, may cause optical devices described herein to selective enable/disable the primary and redundant optical components described above.

In some embodiments, the circuitry 1100 further includes input/output circuitry 1106 that may, in turn, be in communication with the processor 1102 to provide an audible, visual, mechanical, or other output and/or, in some embodiments, to receive an indication of an input from a user or another source. In that sense, the input/output circuitry 1106 may include means for performing analog-to-digital and/or digital-to-analog data conversions. The input/output circuitry 1106 may include support, for example, for a display, touchscreen, keyboard, mouse, image capturing device (e.g., a camera), microphone, and/or other input/output mechanisms. The input/output circuitry 1106 may include a user interface and may include a web user interface, a mobile application, a kiosk, or the like. The input/output circuitry 1106 may interface with one or more units, devices, sensors, actuators, communication modules, storage devices, external processing units, peripheral devices, and/or the like. These outputs may then be transmitted to one or more destinations, such as display units, storage systems, control systems, processors (e.g., processor 1102), network interfaces, peripheral devices, external systems, and/or the like, for further action.

The communications circuitry 1108, in some embodiments, includes any means, such as a device or circuitry embodied in either hardware, software, firmware or a combination of hardware, software, and/or firmware, that is configured to receive and/or transmit data from/to a network and/or any other device, or circuitry associated therewith. In this regard, the communications circuitry 1108 may include, for example, a network interface for enabling communications with a wired or wireless communication network. For example, in some embodiments, communications circuitry 1108 may be configured to receive and/or transmit any data that may be stored by the memory 1104 using any protocol that may be used for communications between computing devices. For example, the communications circuitry 1108 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 1108 may include circuitry for interacting with the antenna(s) to cause transmission of signals via the antenna(e) or to handle receipt of signals received via the antenna(e). These signals may be transmitted using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

Many modifications and other embodiments of the present disclosure will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

1. An optical device comprising:
an optical communication medium;
a primary optical component optically coupled with the optical communication medium;
a redundant optical component optically coupled with the optical communication medium; and
an optical switching element coupled with the primary optical component and the redundant optical component,
wherein the optical switching element is configured to selectively enable operation of the primary optical component and the redundant optical component.

2. The optical device according to claim 1, wherein the optical device is embedded within a Mid-Board Optical Module (MBOM) or Co-Packaged Optics (CPO) module.

3. The optical device according to claim 1, wherein the primary optical component and the redundant optical component are optical transmitters configured to generate optical signals.

4. The optical device according to claim 3, further comprising an optical element optically coupling the primary optical component and the redundant optical component with the optical communication medium.

5. The optical device according to claim 3, wherein the optical switching element comprises a driver and a radiofrequency (RF) switch operably coupled with the driver.

6. The optical device according to claim 5, wherein the driver is configured to transmit a control signal to the RF switch that causes either the primary optical component or the redundant optical component to generate optical signals.

7. The optical device according to claim 1, wherein the optical switching element is, in response to one or more operational characteristics of the primary optical component, configured to:
disable operation of the primary optical component; and
enable operation of the redundant optical component.

8. The optical device according to claim 7, wherein at least one of the one or more operational characteristics of the primary optical component are indicative of a failure condition of the primary optical component.

9. The optical device according to claim 1, wherein the redundant optical component comprises a plurality of redundant optical components, and a number of the plurality of redundant optical components is based on the mean time between failures (MTBF) associated with the optical device.

10. The optical device according to claim 1, wherein the optical communication medium is an optical fiber.

11. The optical device according to claim 3, further comprising at least a first optical receiver.

12. The optical device according to claim 11, wherein the first optical receiver is one of a plurality of optical receivers, and a number of optical transmitters is greater than a number of optical receivers forming the plurality.

13. The optical device according to claim 11, wherein the first optical receiver is one of a plurality of optical receivers, and a number of optical transmitters is less than a number of optical receivers forming the plurality.

14. The optical device according to claim 1, wherein the primary optical component and the redundant optical component are optical receivers configured to receive optical signals.

15. The optical device according to claim 14, wherein the optical switching element comprises:
an optical transimpedance amplifier (TIA);
a radiofrequency (RF) switch operably coupled with the TIA, the primary optical component, and the redundant optical component; and
an optical switch operably coupled with the optical communication medium.

16. The optical device according to claim 15, wherein the TIA is configured to transmit a control signal to the optical switch that causes optical signals received via the optical communication medium to be directed to either the primary optical component or the redundant optical component.

17. The optical device according to claim 15, further comprising:
a first optical element operably coupling the primary optical component with the optical switch; and
a second optical element operably coupling the redundant optical component with the optical switch.

18. The optical device according to claim 14, wherein the optical switching element comprises:
a multiplexer (MUX);
a first optical transimpedance amplifier (TIA) operably coupled with the primary optical component;
a second optical TIA operably coupled with the redundant optical component; and
an optical switch operably coupled with the optical communication medium.

19. The optical device according to claim 18, wherein the MUX is configured to transmit a control signal to the optical switch that causes optical signals received via the optical communication medium to be directed to either the primary optical component or the redundant optical component.

20. The optical device according to claim 18, further comprising:
a first optical element operably coupling the primary optical component with the optical switch; and
a second optical element operably coupling the redundant optical component with the optical switch.

21. The optical device according to claim 14, further comprising at least a first optical transmitter.

22. The optical device according to claim 21, wherein the first optical transmitter is one of a plurality of optical transmitters, and a number of optical receivers is greater than a number of optical transmitters forming the plurality.

23. The optical device according to claim 21, wherein the first optical transmitter is one of a plurality of optical transmitters, and a number of optical receivers is less than a number of optical transmitters forming the plurality.

24. The optical device according to claim 2, wherein the MBOM or CPO module is modular such that the MBOM or CPO module supports a plurality of redundant optical components based on the mean time between failures (MTBF) associated with the optical device.

25. An optical transceiver comprising:
an optical communication medium;
a primary optical transmitter optically coupled with the optical communication medium;
a redundant optical transmitter optically coupled with the optical communication medium;
a first optical switching element coupled with the primary optical transmitter and the redundant optical transmitter, wherein the first optical switching element is configured to selectively enable operation of the primary optical transmitter and the redundant optical transmitter;
a primary optical receiver optically coupled with the optical communication medium;
a redundant optical receiver optically coupled with the optical communication medium; and
a second optical switching element coupled with the primary optical receiver and the redundant optical receiver, wherein the second optical switching element is configured to selectively enable operation of the primary optical receiver and the redundant optical receiver.

26. The optical transceiver according to claim 25, wherein the optical transceiver is embedded within a Mid-Board Optical Module (MBOM) or Co-Packaged Optics (CPO) module.

27. The optical transceiver according to claim 26, wherein the MBOM or CPO module is modular such that the MBOM or CPO module supports a plurality of redundant optical components based on the mean time between failures (MTBF) associated with the optical transceiver.
